(19) United States
(12) Patent Application Publication
(10) Pub. No.: US 2003/0083824 A1
(43) Pub. Date: May 1, 2003

(54) Method and system for selecting a best case set of factors for a chemical reaction

(75) Inventor: James Norman Cawse, Pittsfield, MA (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(73) Assignee: General Electric Company

(21) Appl. No.: 09/943,318

(22) Filed: Aug. 31, 2001

(51) Int. Cl. G06F 19/00

(52) U.S. Cl. 702/22

(57) ABSTRACT

A method selects a best case set of factor levels of a catalyzed chemical reaction by defining a chemical experimental space by a Latin square design and conducting a CHTS method to select a best case set of factor levels from the chemical experimental space. A system for investigating a catalyzed experimental space comprises a programmed controller that defines a catalyzed chemical experimental space according to a Latin square strategy and a reactor for effecting a CHTS method on the catalyzed chemical experimental space to produce results.

This invention was made with government support under Contract No. 70NANB9H3038 awarded by NIST. The government may have certain rights to the invention.

### BACKGROUND OF THE INVENTION

The present invention relates to a method and system for selecting a best case set of factor levels for a catalyzed chemical reaction. Particularly, the invention is directed to a method and system for defining a catalyzed chemical experimental space and conducting a combinatorial high throughput screening (CHTS) of the experimental space to determine a best case set of reaction factor levels.

Combinatorial organic synthesis (COS) is a high throughput screening (HTS) methodology that has been developed for pharmaceuticals. COS uses systematic and repetitive synthesis to produce diverse molecular entities formed from sets of chemical “building blocks.” As with traditional research, COS relies on experimental synthesis methodology. However instead of synthesizing a single compound, COS exploits automation and miniaturization to produce large libraries of compounds through successive stages, each of which produces a chemical modification of an existing molecule of a preceding stage. A library is a physical, trackable collection of samples resulting from a definable set of processes or reaction steps. The libraries comprise compounds that can be screened for various activities.

BIOFOCUS, WO99/26901, discloses a COS method for designing a chemical substance having a desired physical property. The method comprises; (a) selecting r (r∃3) sets of candidate elements C₁, C₂ . . . Cᵣ; (b) generating an all-combinations array of possible substances, each element of the array being representative of a different substance having one element chosen from each of the sets C₁, . . . Cᵣ; (c) defining a sub-array within the all-combinations array, the sub-array being smaller than the all-combinations array but including all possible pairings of candidate elements; (d) synthesizing the possible substances in the sub-array and measuring physical properties for each synthesized substance; (e) using the measured physical properties to predict the characteristics of the possible substances in the all-combinations array, which have not been synthesized; (f) selecting and synthesizing further possible substances on the basis of their predicted characteristics, and measuring the physical properties for each synthesized further possible substance; and (g) repeating steps (e) and (f) one or more times until a substance has been synthesized, which displays a characteristic sufficiently close to the desired physical property. A Latin square or a set of orthogonal Latin squares can define the sub-array. The BIOFOCUS sub-array is optimized such that each element within a given set of candidate elements is paired exactly once with each element within each other set of candidates. Alternatively, the sub-array is defined by two Latin squares.

The protocol of COS has been applied to the investigation of chemical processes to produce materials. For example, the development of materials such as phosphors for lighting applications can involve the testing of gradient arrays of materials by a methodology called combinatorial high throughput screening (CHTS). Sun, Combinatorial Search for Advanced Luminescence Materials, Biotechnology and Bioengineering (Combinatorial Chemistry), vol. 61, 4, pp. 193, 201 (1999).

However, success of a methodology to examine a catalyzed reaction experimental space cannot be predicted from a COS based protocol to discover a chemical substance. First, the factors in designing a catalyzed reaction are more complex than the factors to design a chemical substance. While a design of a chemical substance may involve the investigation of a number of substituting moieties of a central molecule, a catalyst system can involve not only combinations of reactants but also combinations of catalysts and reaction conditions. Even a simple catalyzed chemical process may have five or six critical reactant, catalyst and/or condition factors, each of which can have 2 to 20 levels. T. E. Mallouk et al. in Science, 1998, 1735 shows that effective ternary combinations can exist in systems in which none of the binary combinations are effective. On the other hand as seen in FIG. 1, the number of tertiary, 4-way, 5-way, and 6-way factor combinations can rapidly become extremely large, depending on the number of levels for each factor. Accordingly, it may be necessary to search enormous numbers of combinations to find a handful of “leads” (i.e., combinations that may lead to commercially valuable applications).

Another problem is that catalyzed chemical reactions can be unpredictable. Well-known protocols in one area of chemistry cannot be applied to another area with assurance of success. For example, “[d]ue to the complicated mechanistic nature of many transition metal based catalysts, structure—activity relationships are often unpredictable, leaving empirical exploration and serendipity the most common routes to discovery.” J. Tian & G. W. Coates, Angew. Chem Int. Ed. 2000, 39, p 3626. For example, U.S. Pat. No. 6,143,914 shows that some combinations of various metals unexpectedly increase a carbonylation catalyst turnover number (TON) and other related combinations do not.

There is a need for a methodology for specifying an arrangement of formulations and processing conditions so that synergistic interactions of catalyzed chemical reaction variables can be reliably and efficaciously detected. The methodology must provide a design strategy for systems with complex physical, chemical and structural requirements. There is a need for a method and system to specify materials to be synthesized and conditions for CHTS processing so that synergistic interactions of a catalyzed reaction can be detected.

### BRIEF SUMMARY OF THE INVENTION

The invention provides a method for selecting a best case set of factor levels for a catalyzed reaction. In the method, a chemical experimental space is defined by a Latin square design and a CHTS method is conducted to select a best case set of factor levels from the chemical experimental space. A system for investigating a catalyzed experimental space comprises a programmed controller that defines a catalyzed chemical experimental space according to a Latin square strategy and a reactor for effecting a CHTS method on the catalyzed chemical experimental space to produce results.

In an embodiment, a set of reactant factors and their levels and a set of process factors and their levels are selected. the levels are ordered by a Latin square strategy to define an experimental space, a CHTS method is effected by performing runs of the experimental space in a CHTS system, data from the runs is analyzed with graphical and statistical tools to determine a set of factor levels that provides a best result from the experimental space, whether the set of factor levels is a significant set is determined by examination by a statistical technique comprising Percent of Variance Explained and Tukey Simultaneous Test and the process is reiterated if values of the best factor levels are not significant.

### BRIEF DESCRIPTION OF THE DRAWINGS

FIG. 1 is a graph of six factor combinations; and

FIG. 2 is a schematic representation of a CHTS system.

### DETAILED DESCRIPTION OF THE INVENTION

According to the invention, a set of reactant factors and their levels and a set of process factors and their levels are selected by an experimenter. The levels are ordered by a Latin square strategy to define an experimental space. A CHTS method is effected by performing runs of the experimental space in a CHTS system. The data from the runs are analyzed with graphical and statistical tools to determine a set of factor levels that provides a best result from the experimental space. A determination can be made as to whether the set of factor levels is a minimal set by examination by a statistical technique such as Percent of Variance Explained and Tukey Simultaneous Test. If the values of the best factor levels are not significant, the process is reiterated, either by replication with the same or a reduced number of factor levels to reduce overall error or by application of a different design such as a split plot design.

A Latin square is a two-dimensional array or matrix of symbols, such that each row and each column contains each symbol exactly once. A Latin square matrix representing t number of factors can be generated by (1) postulating a t×t sized matrix; (2) designating the factors with letters of the alphabet; (3) assigning the letters in alphabetical order beginning with A to a first matrix row of t units; and (4) assigning subsequent alphabetically ordered representative letters to succeeding t number of rows, beginning each row with an alphabetically succeeding letter until the matrix is filled.

The Latin square strategy can include a Graeco-Latin square (4 factors) design or to the hyper-Graeco-Latin square (5 factors). The strategy can be generalized further to Youden squares, which allow for factors with unequal numbers of levels.

The Graeco-Latin square with an odd number of factors per side of 3 or more can be generated by first constructing a Latin square as described and then constructing a second Latin square with reversed letters. The second square can be represented in Greek letters to distinguish the two matrices. The squares are superimposed to form the Graeco-Latin square. An additional Graeco-Latin square can be generated with the same factors by switching two columns of the first formed square. The procedure can be repeated to generate a multiplicity of squares. The number of random switches of rows or columns needed can be at least as large as the number of rows/columns in order to effect a significant randomization of the initial pattern.

A 5×5 Latin square for five levels of a first metal (M1: Fe, Cu, Ni, Pb, Re); five levels of a second metal (M2: V, W, Ce, La, Sn); and five levels of solvent (dimethylformamide (DMFA), dimethylacetamide (DMAA), tetrahydrofuran (THF), diglyme (DiGly) and diethylacetamide (DEAA)) is shown below in TABLE 1:

TABLE 1

M1

| M2 | Fe | Cu | Ni | Pb | Re |
|---|---|---|---|---|---|
| V | DMFA | DMAA | THF | DiGly | DEAA |
| W | DMAA | THF | DiGly | DEAA | DMFA |
| Ce | THF | DiGly | DEAA | DMFA | DMAA |
| La | DiGly | DEAA | DMFA | DMAA | THF |
| Sn | DEAA | DMFA | DMAA | THF | DiGly |

A statistical model for a Latin square can be represented as in formula (I):

$${y}_{ijk} = μ + {α}_{i} + {τ}_{j} + {β}_{k} + {ϵ}_{ijk} \{ \begin{matrix}i = 1 , 2 … , p \\ j = 1 , 2 … , p \\ k = 1 , 2 … , p\end{matrix} \qquad ( I )$$

where yᵢⱼₖ is an observation in the ith row and kth column for the jth factor,: is the overall mean, α₁ is the ith row effect, τⱼ is the jth level effect, βk is the kth column effect, and εᵢⱼₖ is random error. The model is additive; that is, there are no interactions between rows, columns and treatments. Because there is only one observation in each cell, only two of the three subscripts i, j and k are needed to denote a particular observation.

According to the invention, the Latin square experimental space design is applied in a CHTS method and system to identify best factor levels for a catalyzed chemical reaction.. CHTS is an HTS methodology that incorporates characteristics of COS. The steps of a CHTS methodology can be broken down into generic operations including selecting chemicals to be used in an experiment; introducing the chemicals into a formulation system (typically by weighing and dissolving to form stock solutions), combining aliquots of the solutions into formulations or mixtures in a geometrical array (typically by the use of a pipetting robot); processing the array of chemical combinations into products and analyzing properties of the products. Results from the analyzing step can be used to compare properties of the products in order to discover “leads”—materials whose properties indicate commercial potential.

Typically, CHTS methodology is characterized by parallel reactions at a micro scale. In one aspect, CHTS can be described as a method comprising (A) an iteration of steps of (i) selecting a reactant, catalyst or condition set; (ii) reacting the set; and (iii) evaluating products of the reacting step; and (B) reiterating step (A) wherein a successive reactant, catalyst or condition set selected for a step (i) is chosen as a result of an evaluating step (iii) of a preceding iteration.

In another CHTS method, a multiplicity of tagged reactants is subjected to an iteration of steps of (A) (i) simultaneously reacting the reactants, (ii) identifying a multiplicity of tagged products of the reaction and (B) evaluating the identified products after completion of a single or repeated iteration (A). A CHTS can utilize advanced automated, robotic, computerized and controlled loading, reacting and evaluating procedures.

These and other features will become apparent from the drawings and following detailed discussion, which by way of example without limitation describe preferred embodiments of the present invention.

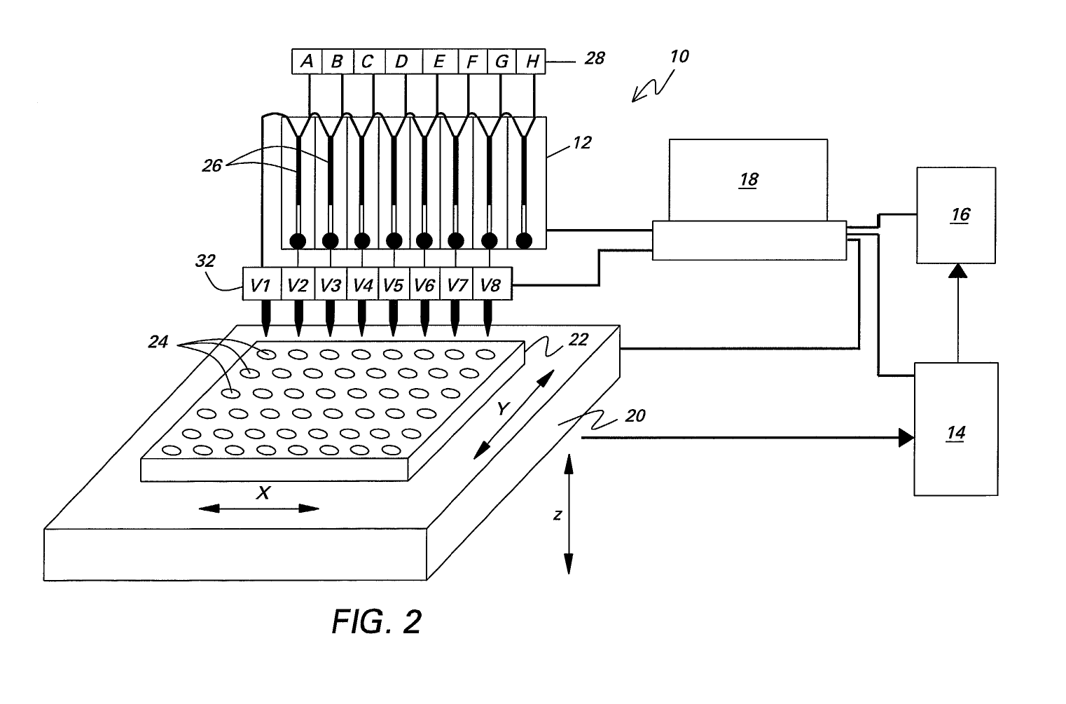

FIG. 2 is a schematic representation of a system 10 for CHTS according to the invention. FIG. 2 shows system 10 including dispensing assembly 12, reactor 14, detector 16 and controller 18. Further shown, is X-Y-Z robotic positioning stage 20, which supports array plate 22 with wells 24. The dispensing assembly 12 includes a battery of pipettes 26 that are controlled by controller 18. X-Y-Z robotic positioning stage 20 is controlled by controller 18 to position wells 24 of the array plate 22 beneath displacement pipettes 26 for delivery of test solutions from reservoirs 28.

Controller 18 controls aspiration of precursor solution into the battery of pipettes 26 and sequential positioning of the wells 24 of array plate 22 so that a prescribed stoichiometry and/or composition of reactant and/or catalyst can be delivered to the wells 24. By coordinating activation of the pipettes 26 and movement of plate 22 on the robotic X-Y-Z stage 20, a library of materials can be generated in a two-dimensional array for use in the CHTS method. Also, the controller 18 can be used to control sequence of charging of sample to reactor 14 and to control operation of the reactor 14 and the detector 16. Controller 18 can be a computer, processor, microprocessor or the like.

An experimental space is defined according to a Latin square design that is embodied as a program resident in controller 18. Controller 18 translates the defined space into a loading specification for array plate 33. Then controller 18 controls the operation of pipettes 26 and stage 20 according to the specification to deliver reactant and/or catalyst to the wells 34 of plate 22.

Additionally, the controller 18 controls the sequence of charging array plate 22 into the reactor 14, which is synchronized with operation of detector 16. Detector 16 detects products of reaction in the wells 24 of array plate 22 after reaction in reactor 14. Detector 16 can utilize chromatography, infra red spectroscopy, mass spectroscopy, laser mass spectroscopy, microspectroscopy, NMR or the like to determine the constituency of each reaction product. The controller 18 uses data on the sample charged by the pipettes 26 and on the constituency of reaction product for each sample from detector 16 to correlate a detected product with at least one varying parameter of reaction.

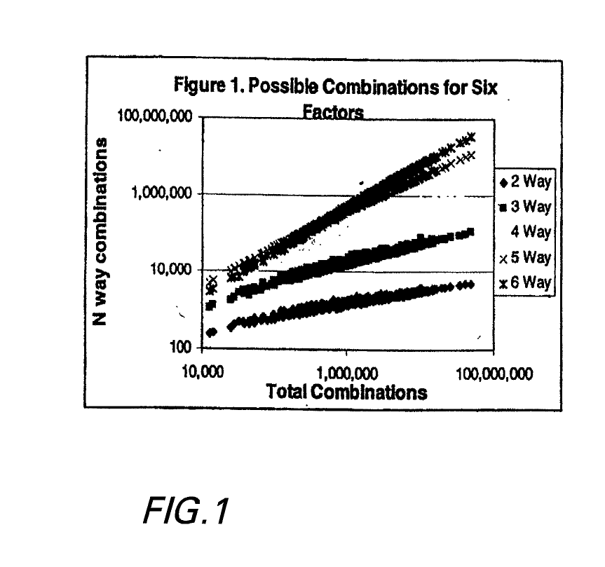

As an example, if the method and system of FIG. 1 is applied to study a carbonylation catalyst and/or to determine optimum carbonylation reaction conditions, the detector 16 analyzes the contents of the well for carbonylated product. In this case, the detector 16 can use Raman spectroscopy. The Raman peak is integrated using the analyzer electronics and the resulting data can be stored in the controller 18. Other analytical methods may be used—for example, Infrared spectrometry, mass spectrometry, headspace gas-liquid chromatography and fluorescence detection.

A method of screening complex catalyzed chemical reactions can be conducted in the FIG. 1 system 10. According to the method, catalyzed formulations are prepared according to a Latin square design. For example, a Latin square design can specify a combination of reactants, catalysts and conditions as a multiphase reactant system. In this procedure, a formulation is prepared that represents a first reactant system that is at least partially embodied in a liquid. Each formulation is loaded as a thin film to a respective well 24 of the array plate 22 and the plate 22 is charged into reactor 14. During the subsequent reaction, the liquid of the first reactant system embodied is contacted with a second reactant system at least partially embodied in a gas. The liquid forms a film having a thickness sufficient to allow the reaction rate of the reaction to be essentially independent of the mass transfer rate of the second reactant system into the liquid.

In one embodiment, the invention is applied to study a process for preparing diaryl carbonates. Diaryl carbonates such as diphenyl carbonate can be prepared by reaction of hydroxyaromatic compounds such as phenol with oxygen and carbon monoxide in the presence of a catalyst composition comprising a Group VIIIB metal such as palladium or a compound thereof, a bromide source such as a quaternary ammonium or hexaalkylguanidinium bromide and a polyaniline in partially oxidized and partially reduced form. The invention can be applied to screen for a catalyst to prepare a diaryl carbonate by carbonylation.

Various methods for the preparation of diaryl carbonates by a carbonylation reaction of hydroxyaromatic compounds with carbon monoxide and oxygen have been disclosed. The carbonylation reaction requires a rather complex catalyst. Reference is made, for example, to Chaudhari et al., U.S. Pat. No. 5,917,077. The catalyst compositions described therein comprise a Group VIIIB metal (i.e., a metal selected from the group consisting of ruthenium, rhodium, palladium, osmium, iridium and platinum) or a complex thereof.

The catalyst material also includes a bromide source. This may be a quaternary ammonium or quaternary phosphonium bromide or a hexaalkylguanidinium bromide. The guanidinium salts are often preferred; they include the ∀,T-bis(pentaalkylguanidinium)alkane salts. Salts in which the alkyl groups contain 2-6 carbon atoms and especially tetra-n-butylammonium bromide and hexaethylguanidinium bromide are particularly preferred.

Other catalytic constituents are necessary in accordance with Chaudhari et al. The constituents include inorganic cocatalysts, typically complexes of cobalt(II) salts with organic compounds capable of forming complexes, especially pentadentate complexes. Illustrative organic compounds of this type are nitrogen-heterocyclic compounds including pyridines, bipyridines, terpyridines, quinolines, isoquinolines and biquinolines; aliphatic polyamines such as ethylenediamine and tetraalkylethylenediamines; crown ethers; aromatic or aliphatic amine ethers such as cryptanes; and Schiff bases. The especially preferred inorganic cocatalyst in many instances is a cobalt(II) complex with bis-3-(salicylalamino)propylmethylamine.

Organic cocatalysts may be present. These cocatalysts include various terpyridine, phenanthroline, quinoline and isoquinoline compounds including 2,2′:6′,2″-terpyridine, 4-methylthio-2,2′:6′,2″-terpyridine and 2,2′:6′,2″-terpyridine N-oxide,1,10-phenanthroline, 2,4,7,8-tetramethyl-1,10-phenanthroline, 4,7-diphenyl-1,10,phenanthroline and 3,4,7,8-tetramethy-1,10-phenanthroline. The terpyridines and especially 2,2′:6′,2″-terpyridine are preferred.

Another catalyst constituent is a polyaniline in partially oxidized and partially reduced form.

Any hydroxyaromatic compound may be employed. Monohydroxyaromatic compounds, such as phenol, the cresols, the xylenols and p-cumylphenol are preferred with phenol being most preferred. The method may be employed with dihydroxyaromatic compounds such as resorcinol, hydroquinone and 2,2-bis(4-hydroxyphenyl)propane or “bisphenol A,” whereupon the products are polycarbonates.

Other reagents in the carbonylation process are oxygen and carbon monoxide, which react with the phenol to form the desired diaryl carbonate.

The following EXAMPLE is illustrative and should not be construed as a limitation on the scope of the claims unless a limitation is specifically recited.

### EXAMPLE

This EXAMPLE illustrates the identification of an active and selective catalyst for the production of aromatic carbonates. The procedure identifies the factor levels contributing to the best catalyst from within a complex chemical space, where the chemical space is defined as an assemblage of all possible experimental conditions defined by a set of variable parameters such as formulation ingredient identity or amount. The formulation parameters are given in TABLE 2:

TABLE 2

| | | Formulation |
|---|---|---|
| | Formulation | Amount |
| | Type Parameter | Parameter |
| | Variation | Variation |
| Precious metal | Held Constant | Held Constant |
| catalyst Primary | Fe, Cu, Ni, Pb, Re (as their | 5 (as molar ratios to |
| Transition Metal | acetylacetonates) | precious metal |
| Cocatalyst (TM) | V, W, Ce, La, Sn (as their | catalyst) |
| Secondary Metal | acetylacetonates) | 5 (as molar |
| Cocatalyst (LM) | Dimethylformamide (DMFA), | ratios to |
| Cosolvent (CS) | Dimethylacetamide (DMAA), | precious metal |
| | Diethyl acetamide (DEAA), | catalyst) |
| | Tetrahydrofuran (THF), | 500 (as molar |
| | Diglyme (DiGly) | ratios to |
| | | precious metal |
| | | catalyst) |
| Hydroxyaromatic | Held constant | Sufficient added |
| compound | | to achieve constant |
| | | sample volume |

The chemical space defined by the parameters of TABLE 2 has 125 factor levels. This is a large experiment that can be simplified according to the invention. A Latin square design is generated according to a computer algorithm that first postulates a 5×5 matrix of levels of the first two formulation factors. Levels of the third formulation factor are sequentially added to the first row of the array. Levels of the remaining formulation factor are sequentially added to each subsequent row of the matrix. Representations of the added levels are permuted by one element with each addition (e.g. ABCDE->BCDEA). The result can be represented as shown above in TABLE 1. Rows of the TABLE 1 representation are then randomly interchanged with rows and columns are randomly interchanged with columns a total of 5 times to generate a randomized set. The resulting representation is converted to the TABLE 3 representation to facilitate loading of arrays to conduct a CHTS experimental evaluation.

In the evaluation, each metal acetylacetonate and each cosolvent is made up as a stock solution in phenol. Ten ml of each stock solution are produced by manual weighing and mixing. An appropriate quantity of each stock solution is then dispensed into a single 2-ml vial using a Hamilton MicroLab 4000 laboratory robot. Each resulting mixture is stirred using a miniature magnetic stirrer and then 25 microliters of each mixture are measured out by the robot to individual 2-ml vials. The vials are placed in to an array holder tray.

The assembled tray is then placed in an Autoclave Engineers 1-gallon autoclave, pressurized to 1500 psi (100 atm) with a 10% O₂ in CO mixture to give a 10 atm oxygen partial pressure. The tray is heated to 100° C. for two hours, cooled, depressurized and removed from the Autoclave. Vial contents are evaluated by gas-liquid chromatography. Performance is expressed numerically as a catalyst turnover number or TON in TABLE 3. TON is defined as the number of moles of aromatic carbonate produced per mole of Palladium catalyst charged.

TABLE 3

| Metal1 | Metal2 | Solvent | TON |
|---|---|---|---|
| Re | V | DMFA | 991 |
| Re | W | DMAA | 982 |
| Re | Ce | THF | 873 |
| Re | La | DiGly | 1040 |
| Re | Sn | DEAA | 867 |
| Pb | V | DMAA | 766 |
| Pb | W | THF | 652 |
| Pb | Ce | DiGly | 593 |
| Pb | La | DEAA | 868 |
| Pb | Sn | DMFA | 695 |
| Ni | V | THF | 629 |
| Ni | W | DiGly | 663 |
| Ni | Ce | DEAA | 616 |
| Ni | La | DMFA | 816 |
| Ni | Sn | DMAA | 643 |
| Cu | V | DiGly | 686 |
| Cu | W | DEAA | 599 |
| Cu | Ce | DMFA | 683 |
| Cu | La | DMAA | 831 |
| Cu | Sn | THF | 686 |
| Fe | V | DEAA | 645 |
| Fe | W | DMFA | 606 |
| Fe | Ce | DMAA | 607 |
| Fe | La | THF | 710 |
| Fe | Sn | DiGly | 665 |

The results are analyzed by analysis of variance (ANOVA) for all main effects in the data. The ANOVA results are given in TABLE 4.

TABLE 4

| | | | % | | | | |
|---|---|---|---|---|---|---|---|
| Source | DF | Seq SS | of Var | MS | F | P | Significant? |
| Metal1 | 4 | 299510 | 69.5 | 74878 | 40.91 | 0 | Yes |
| Metal2 | 4 | 97102 | 22.5 | 24275 | 13.26 | 0 | Yes |
| Cosolvent | 4 | 11918 | 2.7 | 2979 | 1.63 | 0.231 | No |
| Error | 12 | 21966 | 5.1 | 1831 | | | |
| Total | 24 | 430495 | | | | | |

In TABLE 4, Percent of Variance Explained (% of Var) measures the fraction of total variation observed in the experiment that is attributable to a given factor. Percent of Variance Explained is calculated by dividing a sum of squares for a given factor level by the total sum of squares for the system. If a preponderance (for example, at least 80%) of the variance percent is attributable to one or two factor levels, these factor levels can be examined in more detail. The ANOVA analysis of TABLE 4 shows a significant difference among Metal1 and Metal2 results but not among cosolvents. Further comparison among the Metal1 levels and Metal2 levels are conducted according to Tukey Simultaneous Tests. The Tukey Simultaneous Test determines ratios (t values) of mean values of factor levels and standard error. A determination is then made as to whether differences in the ratios are significantly statistically different. The statistically outstanding levels in the ratios are identified as “leads.” TABLE 5 and TABLE 6 show application of Tukey Simultaneous Test and determination of statistical differences.

TABLE 5

| Level | Difference | SE of | | Adjusted | |
|---|---|---|---|---|---|
| Metal1 | of Means | Difference | T-Value | P-Value | Significant? |
| Pb | 235 | 27.06 | 8.684 | <.0001 | YES |
| Ni | 277 | 27.06 | 10.236 | <.0001 | YES |
| Cu | 253 | 27.06 | 9.349 | <.0001 | YES |
| Fe | 304 | 27.06 | 11.234 | <.0001 | YES |

TABLE 5 shows a Difference of Means, which is the mean (average) value of TON when metal1=Fe TON subtracted from the average values of TON when metal1=Cu, Ni, Pb, or Re. The resulting Difference of Means is divided by the standard error of the difference, which is derived from the MS Error in TABLE 4 by the formula (II):

SE of Difference=√(2*MS Error/number of levels) (II)

The resulting ratio is a T-value. The T-value is compared to a multivariate t table to find an adjusted P-value. See G. A Milliken and D. E. Johnson, Analysis of Messy Data, Van Nostrand Reinhold, NY, 1984, p 456. The adjusted P-value is a probability that an observed difference does not come from random variation. Note in TABLE 5, the four metals Pb, Ni, Cu, and Fe are all significantly different from Re. Repeating this process establishes that the four metals are not different from each other.

Similarly for Metal2, TABLE 6 shows that La is significantly different from the other four metals.

TABLE 6

| Level | Difference | SE of | | Adjusted | |
|---|---|---|---|---|---|
| Metal1 | of Means | Difference | T-Value | P-Value | Significant? |
| Ce | 178.6 | 27.06 | 6.60 | 0.0001 | YES |
| Sn | 141.8 | 27.06 | 5.24 | 0.002 | YES |
| V | 109.6 | 27.06 | 4.05 | 0.011 | YES |
| W | 152.6 | 27.06 | 5.64 | 0.001 | YES |

The process establishes that Re is a singularly active Metal1 (TABLE 5) and that La is a similarly active Metal2. (TABLE 6). The EXAMPLE illustrates the identification of active metal leads for a chemical catalyst according to the invention.

While preferred embodiments of the invention have been described, the present invention is capable of variation and modification and therefore should not be limited to the precise details of the Examples. The invention includes changes and alterations that fall within the purview of the following claims.

What is claimed is:

1. A method for selecting a best case set of factor levels of a catalyzed chemical reaction, comprising;
defining a catalyzed chemical experimental space according to a Latin square strategy; and
effecting a combinatorial high throughput screening (CHTS) method on the catalyzed chemical experimental space to select a best case set of factor levels from the catalyzed experimental space.

2. The method of claim 1, wherein the space is defined according to a Graeco-Latin square design.

3. The method of claim 1, wherein the space is defined according to a Hyper-Graeco-Latin square design.

4. The method of claim 1, wherein the space is defined according to a Youden Square design.

5. The method of claim 1, wherein the space is defined by (i) identifying candidate factor levels of the space; and (ii) arranging the candidate factor levels into the chemical experimental space according to a Latin square design.

6. The method of claim 1, wherein the space is defined by a Latin square matrix representing t number of factor levels.

7. The method of claim 1, wherein the space is defined by a Latin square matrix representing t number of factor levels by: (1) postulating a t×t sized matrix; (2) designating factors with letters of the alphabet; (3) assigning the letters in alphabetical order to a first matrix row of t units; and (4) assigning subsequent alphabetically ordered representative letters to succeeding t number of rows, beginning each row with an alphabetically succeeding letter until the matrix is filled.

8. The method of claim 1, wherein the space is defined according to a Latin square design by generating a plurality of tables of factor levels and merging the tables into a single table.

9. The method of claim 1, wherein the space is defined according to a Latin square strategy by generating a plurality of tables of factor levels and merging the tables into a single table by creating a union of tables whenever the tables have factor levels in common.

10. The method of claim 1, wherein the space is defined according to a Latin square design by generating a plurality of tables of factor levels and merging the tables into a single table by creating a merger of tables whenever the tables have factor levels in common and folding a smaller table into a larger table of the tables whenever the tables have no factor level in common.

11. The method of claim 1, wherein results of effecting the CHTS method are analyzed by analysis of variance.

12. The method of claim 1, wherein results of effecting the CHTS method are analyzed by Percent of Variance Explained.

13. The method of claim 1, wherein results of effecting the CHTS method are analyzed by applying Tukey Simultaneous Tests.

14. The method of claim 1, wherein results of effecting the CHTS method are analyzed by determining ratios (t values) of mean values of results and standard error and determining whether differences in the ratios are statistically significantly different to identify leads.

15. The method of claim 1, wherein the experimental space is defined by two or more factors, each having a plurality of possible levels.

16. The method of claim 1, wherein the CHTS comprises effecting parallel chemical reactions of an array of reactants defined as the experimental space.

17. The method of claim 1, wherein the CHTS comprises effecting parallel chemical reactions on a micro scale on reactants defined as the experimental space.

18. The method of claim 1, wherein the CHTS comprises an iteration of steps of simultaneously reacting a multiplicity of tagged reactants and identifying a multiplicity of tagged products of the reaction and evaluating the identified products after completion of a single or repeated iteration.

19. The method of claim 1, wherein the experimental space factor levels comprise reactants, catalysts and conditions and the CHTS comprises
(A) (a) reacting a reactant selected from the experimental space under a selected set of catalysts or reaction conditions; and (b) evaluating a set of products of the reacting step; and
(B) reiterating step (A) wherein a selected experimental space selected for a step (a) is chosen as a result of an evaluating step (b) of a preceding iteration of step (A).

20. The method of claim 19, wherein the evaluating step (b) comprises identifying relationships between factor levels of the candidate chemical reaction space; and determining the chemical experimental space according to a Latin square design for the next iteration.

21. The method of claim 19, comprising reiterating (A) until a best set of factor levels of the chemical experimental space is selected.

22. The method of claim 1, wherein the chemical space includes a catalyst system comprising a Group VIII B metal.

23. The method of claim 1, wherein the chemical space includes a catalyst system comprising palladium.

24. The method of claim 1, wherein the chemical space includes a catalyst system comprising a halide composition.

25. The method of claim 1, wherein the chemical space includes an inorganic co-catalyst.

26. A system for investigating a catalyzed experimental space, comprising;
a programmed controller that defines a catalyzed chemical experimental space according to a Latin square strategy; and
a reactor for effecting a CHTS method on the catalyzed chemical experimental space to produce results.

27. The system of claim 26, wherein the controller is a computer, processor or microprocessor.

28. The system of claim 26, further comprising a dispensing assembly to charge factor levels of reactants or catalysts representing the catalyzed chemical experimental space to wells of an array plate for charging to the reactor.

29. The system of claim 29, comprising a programmed controller to define the catalyzed chemical experimental space and to control the assembly to charge factor levels of reactants or catalysts according to the controller defined space.

30. The system of claim 26, further comprising a detector to detect results of the CHTS method effected in the reactor.

31. A method, comprising:
selecting a set of reactant factors and their levels and a set of process factors and their levels;
ordering the levels by a Latin square strategy to define an experimental space;
effecting a CHTS method by performing runs of the experimental space in a CHTS system;
analyzing data from the runs with graphical and statistical tools to determine a set of factor levels that provides a best result from the experimental space;
determining whether the set of factor levels is a significant set by examination by a statistical technique comprising Percent of Variance Explained and Tukey Simultaneous Test; and
reiterating the process if values of the best factor levels are not significant.

32. The method of claim 31, wherein the CHTS method is effected by introducing chemical combinations representing levels into a formulation system comprising a geometrical array and processing the array of chemical combinations into products.
